(19) United States
(12) Patent Application Publication
(10) Pub. No.: US 2011/0209628 A1
(43) Pub. Date: Sep. 1, 2011

(54) CONVEYOR OVEN AND METHOD FOR REMOVAL OF NON-SEARED PRODUCTS FROM A CONVEYOR BELT

(75) Inventor: Jason Edward Lauer, Fort Wayne, IN (US)

(73) Assignee: MERCO/SAVORY LLC

(21) Appl. No.: 13/034,990

(22) Filed: Feb. 25, 2011

Related U.S. Application Data
(60) Provisional application No. 61/308,567, filed on Feb. 26, 2010.

(51) Int. Cl. A47J 37/04

(52) U.S. Cl. 99/443 C

(57) ABSTRACT

A conveyor oven having a conveyor belt that extends through an oven chamber for carrying food products for cooking in the oven chamber. A scraping device is positioned near an exit end of the oven chamber to remove any of the food products that stick to the conveyor belt.

### RELATED APPLICATION

This application claims the benefit of U.S. Provisional Application Ser. No. 61/308,567, filed Feb. 26, 2010, the entire contents of which are incorporated herein by reference.

### BACKGROUND

1. Field of the Disclosure

The present disclosure relates generally to a conveyor oven and a method and, in particular, to removal of non-seared food product from a conveyor belt.

2. Description of Related Art

Conveyorized ovens, particularly finishing toasters, include a conveyor belt that moves food from a position where a user places the food on a conveyor belt through an oven cavity where the food is cooked and then transported out of the oven cavity to be retrieved by the user. Moist food sticks to its cooking platform, e.g., conveyor belt, until the food product reaches the same temperature as the cooking platform. In today's food industry, the food needs to be served faster and faster in order to meet the customers' demands. At these extreme times it is nearly impossible for the food to become equal in temperature to the conveyor. This causes the food to stick to the conveyor belt and, thus, there is a need to remove the food that is still adhered to the conveyor belt.

Unfortunately, some of the food product which is being transported on the conveyor belt becomes stuck or affixed to the conveyor belt and cannot be removed by gravitational forces alone. This is undesirable as the stuck or affixed food will remain on the conveyor belt as it returns to the starting or food loading position, resulting in charring or damaging of the food product. Additional, such stuck or affixed food product can get permanently dislodged within the conveyor belt or the conveyorized oven itself, thus causing a fire or damage to the conveyor oven. Finally, the stuck or affixed food product can be dropped into a crumb or waste tray, thus resulting in a loss of food product and thus a loss in revenue to the operator.

Accordingly, there is a need for a conveyor oven that provides for removal of non-seared food product from a conveyor belt.

### SUMMARY OF THE DISCLOSURE

In one embodiment of the cooking oven of the present disclosure, the conveyor oven comprises a housing defining an oven chamber with an inlet. A conveyor extends through the inlet into the oven chamber and comprises a conveyor belt driven to transport food product into the oven chamber. A scraper is supported by the housing at an exit end of the oven chamber in close proximity to the conveyor belt to separate the food product from the conveyor belt.

In another embodiment of the cooking oven of the present disclosure, the scraper is positioned just prior to the conveyor belt making a turn for a return toward the inlet end of the oven chamber.

In another embodiment of the cooking oven of the present disclosure, a tray is disposed below the conveyor belt near the exit end of the oven chamber to thereby deliver food product separated from the conveyor belt to the tray.

In another embodiment of the cooking oven of the present disclosure, the scraper is attached to at least one side wall of the housing.

In another embodiment of the cooking oven of the present disclosure, the scraper scrapes any of the food product, which is stuck to the conveyor belt, away from the conveyor belt.

In another embodiment of the cooking oven of the present disclosure, the scraper has an angled port that is in close proximity to the conveyor belt to separate the food product from the conveyor belt.

In one embodiment of the method of the present disclosure, the method moves the food products with a conveyor belt through an oven chamber of the conveyor oven and separates the food products from the conveyor belt near an exit end of the oven chamber.

In another embodiment of the method of the present disclosure, the food product is separated from the conveyor belt just prior to making a turn for a return toward an inlet end of the oven chamber.

In another embodiment of the method of the present disclosure, the food product separated from the conveyor belt is delivered to a tray.

In another embodiment of the method of the present disclosure, the tray is located below the conveyor belt at the exit end of the oven chamber.

In another embodiment of the method of the present disclosure, the scraper scrapes any of the food product, which is stuck to the conveyor belt, away from the conveyor belt.

In another embodiment of the method of the present disclosure, the scraper has an angled port that is in close proximity to the conveyor belt to separate the food product from the conveyor belt.

The above-described and other advantages and features of the present disclosure will be appreciated and understood by those skilled in the art from the following detailed description and drawings.

### BRIEF DESCRIPTION OF THE DRAWINGS

FIG. 1 is a top side perspective view of a conveyor oven according to the present disclosure.

FIG. 2 is a schematic top view of the conveyor oven of FIG. 1.

FIG. 3 is a schematic side view of the conveyor oven of FIG. 1.

FIG. 4 is a schematic front view of the conveyor oven of FIG. 1.

FIG. 5 is a bottom side perspective view of the conveyor oven of FIG. 1 with the top portion tilted open to allow for cleaning of the components in a bottom compartment thereof.

FIG. 6 is a bottom front perspective view of the conveyor oven hinged open, thereby showing an internal view of the oven and the bottom fan thereof.

FIG. 7 is a schematic top side perspective view of the conveyor oven of FIG. 1 having a first side wall removed.

FIG. 8 is a schematic top side perspective view of the conveyor oven of FIG. 1 having a second side wall removed.

FIG. 10 is a schematic exploded view of the conveyor oven of FIG. 1.

FIG. 11 is a schematic rear right side perspective view of the conveyor oven of FIG. 1.

### DETAILED DESCRIPTION OF THE PREFERRED EMBODIMENT

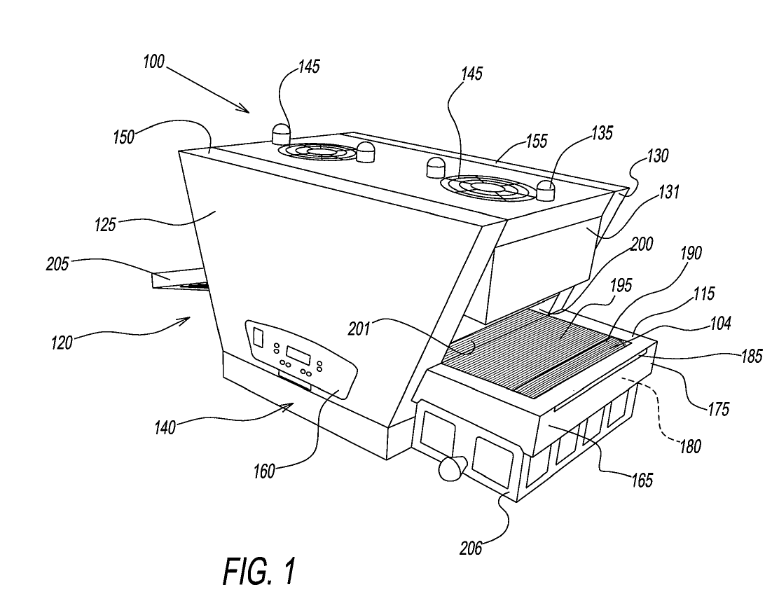

Referring to the drawings and in particular to FIGS. 1-4, an exemplary embodiment of a conveyor oven according to the present disclosure is generally referred to by reference numeral 100. Conveyor oven 100 comprises a conveyor 104, a housing 120 and a conveyor frame 115. Housing 120 has a first side wall 125, a second side wall 130, a first front wall 131, a rear wall 132, a second front wall 133, a bottom wall 225 and a top wall 135 that define an oven cavity or oven chamber 200 having an inlet 201 and an outlet 323. Housing 120 is connected to a bottom compartment 140. Top wall 135 has apertures 145. First side wall 125 covers a first compartment or side wall passage 150. Second side wall 130 covers a second compartment or side wall passage 155. A user interface 160 is disposed on first side wall 125. A user can use user interface 160 to enter data for cooking instructions or other data for conveyor oven 100. Conveyor 104 comprises a conveyor belt 195 that extends through inlet 201 into oven chamber 200 and is supported by housing 120. Conveyor frame 115 surrounds at least a portion of conveyor belt 195 that is outside inlet 201.

Conveyor frame 115 is hollow as defined by an outer wall assembly 165 and an inner wall assembly 170 that form a frame compartment or passage 175 having an interior volume 180 therebetween. Outer wall assembly 165 has apertures 185 therethrough allowing fluid communication between interior volume 180 and an ambient environment surrounding conveyor frame 115. Inner wall assembly 170 is connected to a drive shaft assembly 190, which moves conveyor belt 195. Food is placed on conveyor belt 195 by a user so that conveyor belt 195 moves the food from a position within conveyor frame 115 through oven chamber 200 to a rear tray 205. Conveyor frame 115 may be connected above an external crumb tray 206 that collects any loose debris or particles from conveyor belt 195 due to the user placing food product on conveyor belt 195.

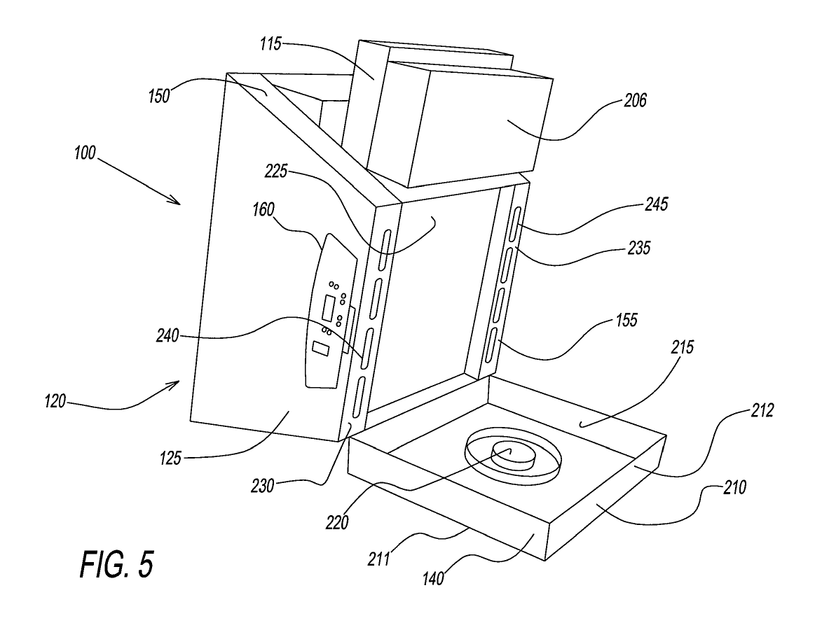

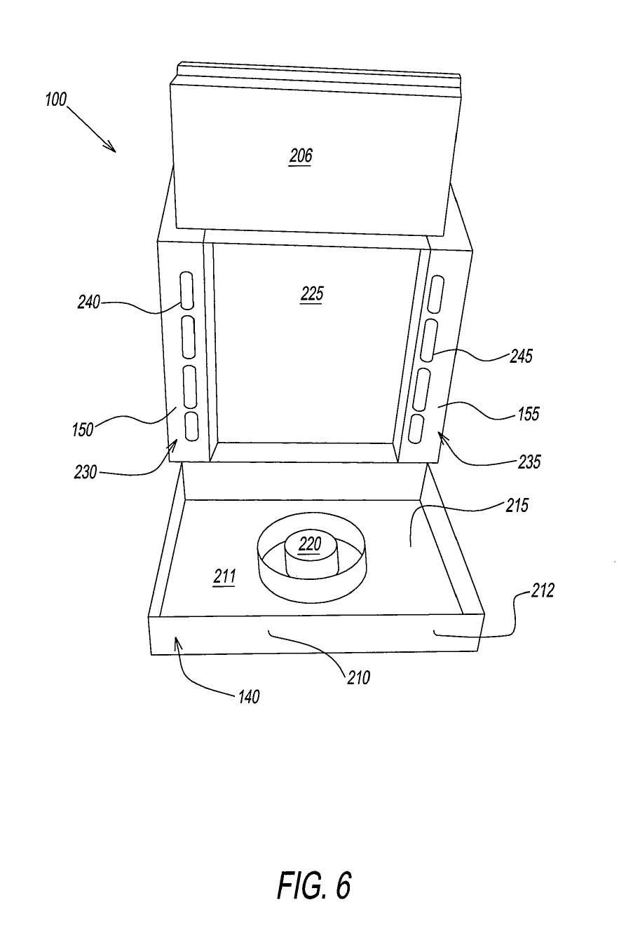

Referring now to FIGS. 3-6, bottom compartment 140 comprises a bottom housing 210 with a base wall 211 and a base side wall 212 forming a bottom interior volume 215 that houses a fan 220. When bottom compartment 140 is connected to housing 120, interior volume 215 is covered by a bottom wall 225 of housing 120 and a first bottom side wall 230 of first compartment 150 and a second bottom side wall 235 of second compartment 155. First bottom side wall 230 has apertures 240 therethrough and second bottom side wall 235 has apertures 245 therethrough to provide fluid communication between interior volume 215 and side wall compartments 150 and 155.

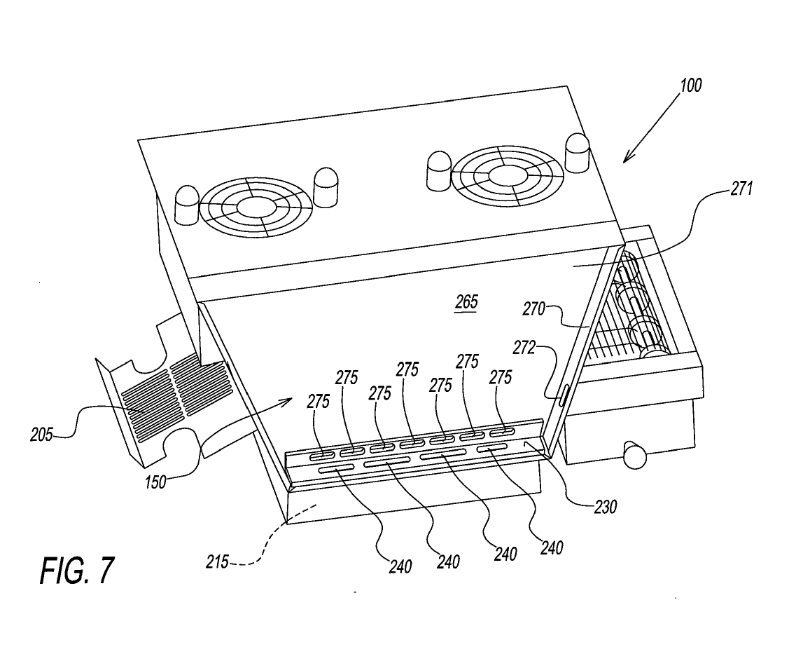

Referring now to FIG. 7, first compartment 150 has a first back panel 265 surrounded by a first compartment side wall 270 forming a first compartment interior 271. First back panel 265 has apertures 275 therethrough adjacent an edge that connects to first bottom side wall 230. First compartment side wall 270 has an aperture 272 therethrough from first compartment interior 271 to interior volume 180 in conveyor frame 115.

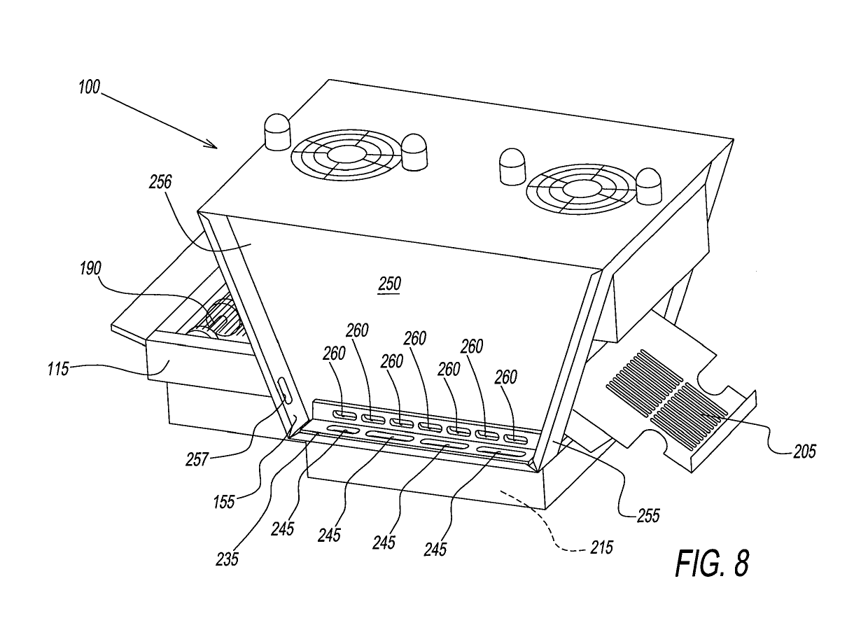

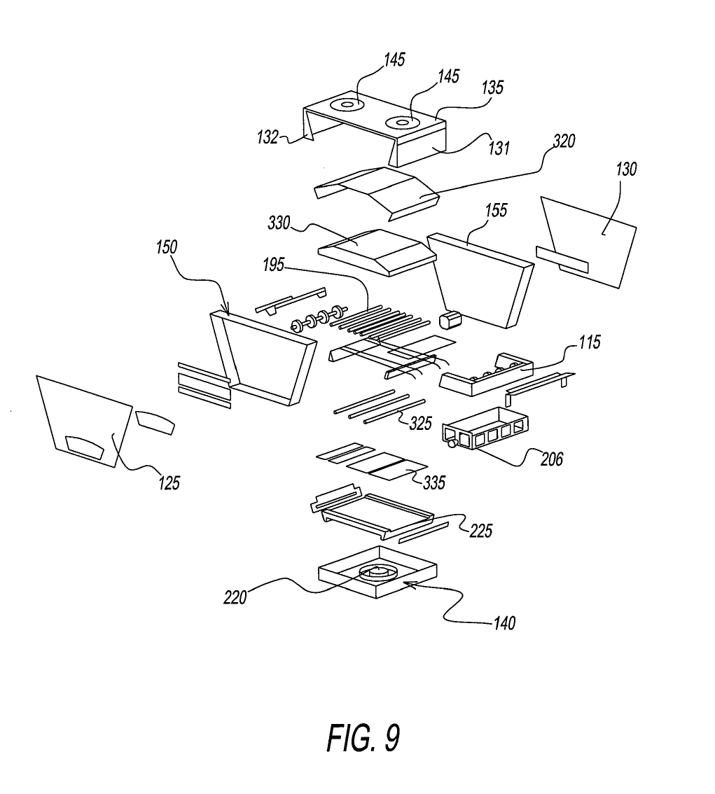

Referring now to FIG. 8, second compartment 155 has a second back panel 250 surrounded by a second compartment side wall 255 forming a second compartment interior 256. Second back panel 250 has apertures 260 therethrough adjacent an edge that connects to second bottom side wall 235. Second compartment side wall 255 has an aperture 257 therethrough from second compartment interior 256 to interior volume 180 in conveyor frame 115.

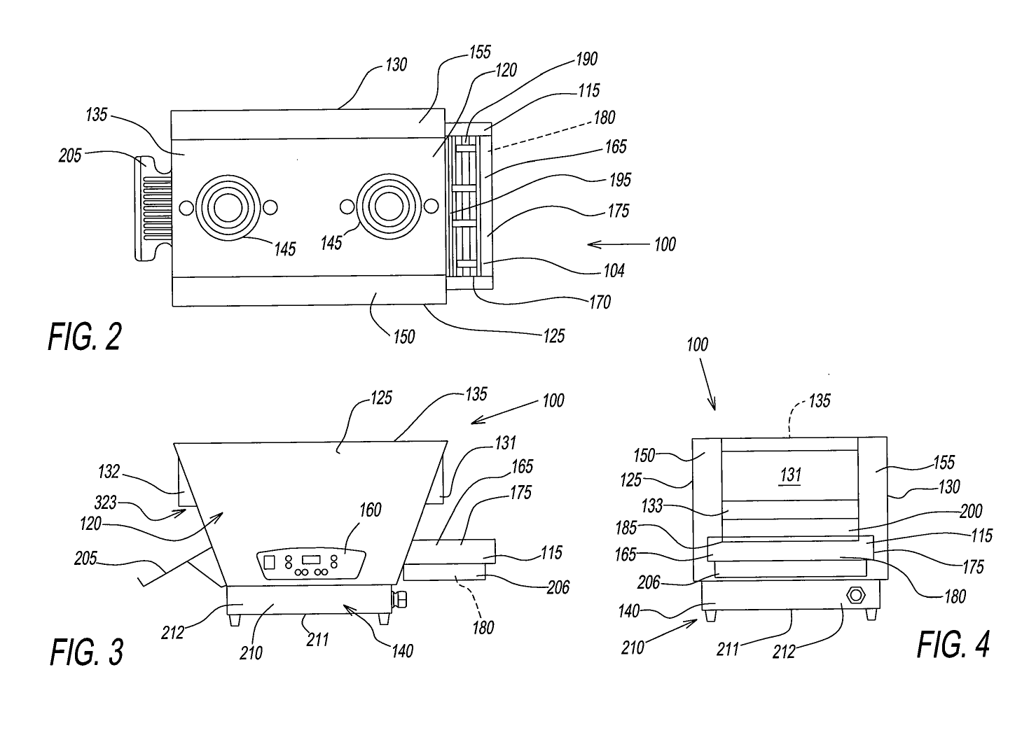

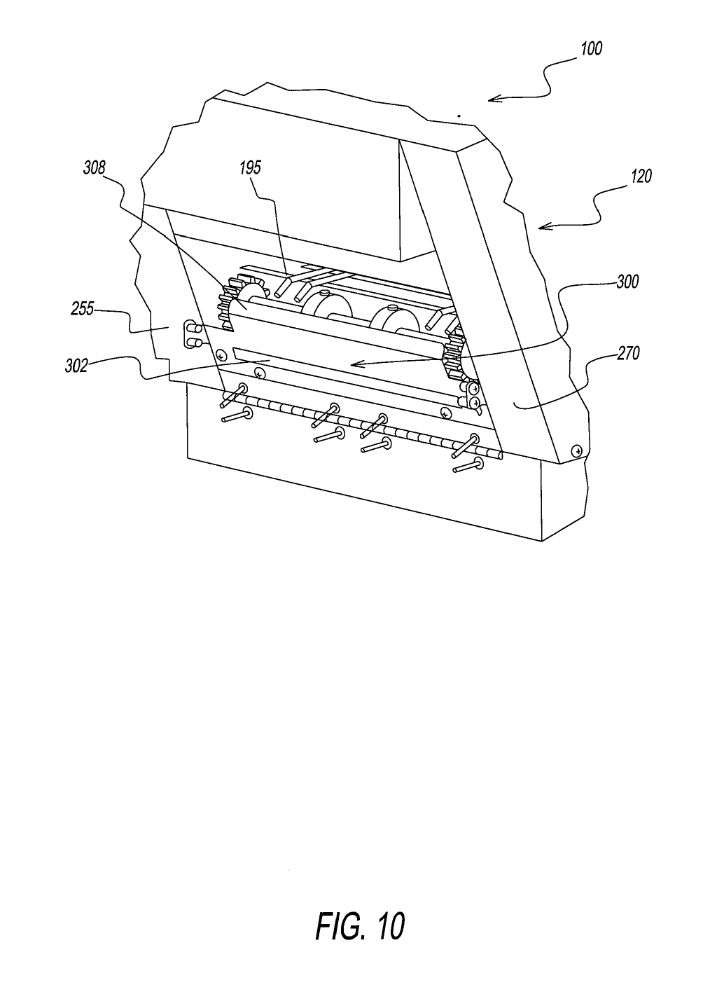

Referring now to FIGS. 9-11, a scraper 300 comprises a flat metallic sheet 302 affixed to housing 120 of conveyor oven 100. Preferably, scraper 300 is attached (e.g., by screws) to first and second compartment side walls 270 and 255, respectively, at an exit end of conveyor oven 100. Scraper 300 has an angled port 308 disposed at the top thereof, in close proximity to conveyor belt 195, just prior to conveyor belt 195 making its turn at the exit side of conveyor oven 100 and between conveyor belt 195 and take off tray 205 (shown in FIGS. 2, 3 and 9). Scraper 300 can be made of any suitable material. Preferably, the material is metal, e.g., sheet metal.

Scraper 300 is placed in such a way that it separates food products from conveyor belt 195 as it makes a turn. In particular, scraper 300 gets between the food (not shown) and conveyor belt 195 to scrape or loosen any food product, which is stuck to conveyor belt 195, thereby allowing the food to break away from conveyor belt 195 and slide down take off tray 205.

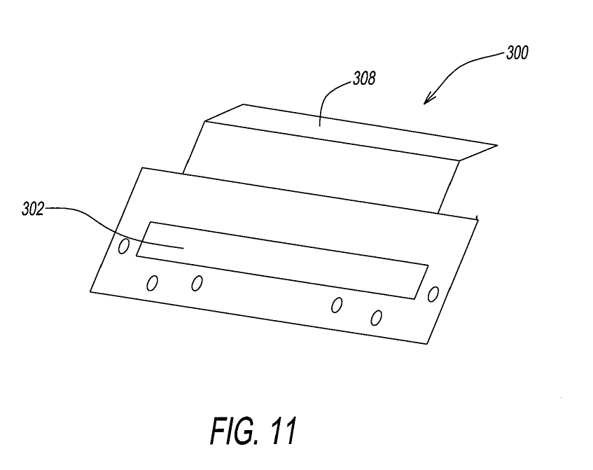

It will be apparent to those of skill in the art that scraper 300 may assume other geometries. For example, in some embodiments the slot shown in flat sheet 302 in FIG. 11 may be eliminated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A conveyor oven comprising:
a housing defining an oven chamber with an inlet;
a conveyor that extends through said inlet into said oven chamber and that comprises a conveyor belt driven to transport food product into said oven chamber; and
a scraper that is supported by said housing at an exit end of said oven chamber in close proximity to said conveyor belt to separate said food product from said conveyor belt.

2. The conveyor oven of claim 1, wherein said port is positioned just prior to said conveyor belt making a turn for a return toward said inlet end of said oven chamber.

3. The conveyor oven of claim 1, further comprising a tray disposed below said conveyor belt near said exit end of said oven chamber, and wherein food product separated from said conveyor belt is delivered to said tray.

4. The conveyor oven of claim 1, wherein said scraper is attached to at least one side wall of said housing.

5. The conveyor oven of claim 1, wherein said scraper scrapes any of said food product, which is stuck to said conveyor belt, away from said conveyor belt.

6. The conveyor oven of claim 1, wherein said scraper has an angled port that is in close proximity to said conveyor belt to separate said food product from said conveyor belt.

7. A method for cooking food products in a conveyor oven comprising:
moving said food products with a conveyor belt through an oven chamber of said conveyor oven; and
separating said food products from said conveyor belt near an exit end of said oven chamber.

8. The method of claim 7, wherein said food product is separated from said conveyor belt just prior to making a turn for a return toward an inlet end of said oven chamber.

9. The method of claim 7, further comprising delivering said food product separated from said conveyor belt to a tray.

10. The method of claim 9, wherein said tray is located below said conveyor belt at said exit end of said oven chamber.

11. The method of claim 7, wherein said scraper scrapes any of said food product, which is stuck to said conveyor belt, away from said conveyor belt.

12. The conveyor oven of claim 7, wherein said scraper has an angled port that is in close proximity to said conveyor belt to separate said food product from said conveyor belt.
